(19) United States
(12) Patent Application Publication
(10) Pub. No.: US 2012/0012674 A1
(43) Pub. Date: Jan. 19, 2012

(54) SPRINKLER BASE

(75) Inventors: Izhak GAL, Kibbutz Naan (IL); Moshe GORNY, Kibbutz Naan (IL)

(73) Assignee: NAANDAN JAIN IRRIGATION C.S. LTD., Kibbutz Naan (IL)

(21) Appl. No.: 12/836,328

(22) Filed: Jul. 14, 2010

(51) Int. Cl. A62C 31/24

(52) U.S. Cl. 239/280

(57) ABSTRACT

A sprinkler support including a base member configured to define an upward facing base surface, a recess extending across the base surface for receiving a water supply conduit, at least one resilient water supply conduit retaining finger located alongside one side of the recess for retaining the water supply conduit with respect to the base surface, at least one first resilient water supply conduit retaining finger receiving aperture formed in the base member for receiving the at least one retaining finger of another base member when stacked therewith in mutually 180 degree rotated, overall registration therewith, at least one second resilient water supply conduit retaining finger receiving aperture formed in the base member for receiving the at least one retaining finger of another base member when stacked therewith in mutually offset relationship therewith and a sprinkler support rod support portion, configured to receive and support an elongated sprinkler support rod.

### FIELD OF THE INVENTION

The present invention relates to irrigation equipment generally and more particularly to sprinkler supports.

### BACKGROUND OF THE INVENTION

The following patent publications are believed to represent the current state of the art:

U.S. Pat. Nos. 6,322,027; 5,836,516; 4,884,749; 4,824,020; 2,694,600 and 2,323,701; and

U.S. Patent Publication No. 2003/0129043.

### SUMMARY OF THE INVENTION

The present invention seeks to provide improved sprinkler supports which are stackable with and without sprinklers and sprinkler rods.

There is thus provided in accordance with a preferred embodiment of the present invention a sprinkler support including a base member configured to define an upward facing base surface, a recess extending across the base surface for receiving a water supply conduit, at least one resilient water supply conduit retaining finger located alongside one side of the recess for retaining the water supply conduit with respect to the base surface, at least one first resilient water supply conduit retaining finger receiving aperture formed in the base member for receiving the at least one resilient water supply conduit retaining finger of another base member when stacked therewith in mutually 180 degree rotated, overall registration therewith, at least one second resilient water supply conduit retaining finger receiving aperture formed in the base member for receiving the at least one resilient water supply conduit retaining finger of another base member when stacked therewith in mutually offset relationship therewith and a sprinkler support rod support portion, configured to receive and support an elongated sprinkler support rod.

Preferably, a slot is formed in the base member for accommodating at least one sprinkler support rod mounted on at least one other base member, when the at least one other base member is stacked therewith in mutually offset relationship therewith.

In accordance with a preferred embodiment of the present invention the sprinkler support also includes a sprinkler support rod mounted on the sprinkler support rod support portion. Additionally, the sprinkler support also includes a sprinkler mounted on the sprinkler support rod. Preferably, the sprinkler is mounted on the sprinkler support rod via a mounting and water connecting element and a water supply tube is connected to the mounting and water connecting element and is adapted for connection to a water supply conduit via a coupler.

In accordance with a preferred embodiment of the present invention the water supply conduit lies in the recess and is retained therein by the at least one resilient water supply conduit retaining finger.

Preferably, the at least one resilient water supply conduit retaining finger clamps the water supply conduit to the base member when the water supply conduit is unpressurized.

There is also provided in accordance with another preferred embodiment of the present invention a sprinkler support including a base member configured to define an upward facing base surface, a recess extending across the base surface for receiving a water supply conduit, a sprinkler support rod support portion, configured to receive and support an elongated sprinkler support rod and a slot formed in the base member for accommodating at least one sprinkler support rod mounted on at least one other base member, when the at least one other base member is stacked therewith in mutually offset relationship therewith.

Preferably, the sprinkler support also includes at least one resilient water supply conduit retaining finger located alongside one side of the recess for limiting lateral movement of the water supply conduit with respect to the base surface. Additionally, the sprinkler support also includes at least one upstanding portion located alongside one side of the recess for limiting lateral movement of the water supply conduit with respect to the base surface.

In accordance with a preferred embodiment of the present invention the sprinkler support also includes a sprinkler support rod mounted on the sprinkler support rod support portion. Additionally, the sprinkler support also includes a sprinkler mounted on the sprinkler support rod. Preferably, the sprinkler is mounted on the sprinkler support rod via a mounting and water connecting element and a water supply conduit is connected to the mounting and water connecting element and is adapted for connection to a water supply conduit via a coupler.

Preferably, the water supply conduit lies in the recess and is retained therein by at least one resilient water supply conduit retaining finger.

There is further provided in accordance with yet another preferred embodiment of the present invention a sprinkler support including a base member configured to define an upward facing base surface, a recess extending across the base surface for receiving a water supply conduit, at least one upstanding portion located alongside one side of the recess for retaining the water supply conduit with respect to the base surface, at least one first upstanding portion receiving aperture formed in the base member for receiving the at least one upstanding portion of another base member when stacked therewith in mutually 180 degree rotated, overall registration therewith, at least one second upstanding portion receiving aperture formed in the base member for receiving the at least one upstanding portion of another base member when stacked therewith in mutually offset relationship therewith and a sprinkler support rod support portion, configured to receive and support an elongated sprinkler support rod.

Preferably, a slot is formed in the base member for accommodating at least one sprinkler support rod mounted on at least one other base member, when the at least one other base member is stacked therewith in mutually offset relationship therewith.

In accordance with a preferred embodiment of the present invention the sprinkler support also includes a sprinkler support rod mounted on the sprinkler support rod support portion. Additionally, the sprinkler support also includes a sprinkler mounted on the sprinkler support rod. Additionally, the sprinkler is mounted on the sprinkler support rod via a mounting and water connecting element and a water supply tube is connected to the mounting and water connecting element and is adapted for connection to a water supply conduit via a coupler.

Preferably, the water supply conduit lies in the recess and is retained therein by the at least one upstanding portion.

### BRIEF DESCRIPTION OF THE DRAWINGS

The present invention will be understood and appreciated more fully from the following detailed description, taken in conjunction with the drawings in which:

FIG. 1 is a simplified pictorial illustration of a sprinkler support in use including a base member and a sprinkler support rod, the sprinkler support being constructed and operative in accordance with a preferred embodiment of the present invention;

FIGS. 2A & 2B are respective simplified illustrations of the top and bottom of a base member forming part of the sprinkler support of FIG. 1

FIG. 3 is a simplified pictorial illustration of multiple base members stacked in mutually 180 degree rotated, overall registration;

FIG. 4A is a simplified sectional illustration, taken along lines IVA-IVA in FIG. 3;

FIG. 4B is a simplified sectional illustration, taken along lines IVB-IVB in FIG. 3;

FIG. 5 is a simplified pictorial illustration of multiple sprinkler supports stacked in mutually offset registration;

FIG. 6A is a simplified sectional illustration, taken along lines VIA-VIA in FIG. 5;

FIG. 6B is a simplified sectional illustration, taken along lines VIB-VIB in FIG. 5.

FIG. 7 is a simplified pictorial illustration of a sprinkler support in use including a base member and a sprinkler support rod, the sprinkler support being constructed and operative in accordance with another preferred embodiment of the present invention;

FIGS. 8A & 8B are respective simplified illustrations of the top and bottom of a base member forming part of the sprinkler support of FIG. 7;

FIG. 9 is a simplified pictorial illustration of multiple base members stacked in mutually 180 degree rotated, overall registration;

FIG. 10A is a simplified sectional illustration, taken along lines XA-XA in FIG. 9;

FIG. 10B is a simplified sectional illustration, taken along lines XB-XB in FIG. 9;

FIG. 11 is a simplified pictorial illustration of multiple sprinkler supports stacked in mutually offset registration;

FIG. 12A is a simplified sectional illustration, taken along lines XIIA-XIIA in FIG. 11;

FIG. 12B is a simplified sectional illustration, taken along lines XIIB-XIIB m FIG. 11; and

FIGS. 13A and 13B are respective simplified illustrations illustrating engagement of the sprinkler support of FIGS. 7-12B with a thin walled water supply conduit in respective pressurized and non-pressurized operative orientations.

### DETAILED DESCRIPTION OF PREFERRED EMBODIMENTS

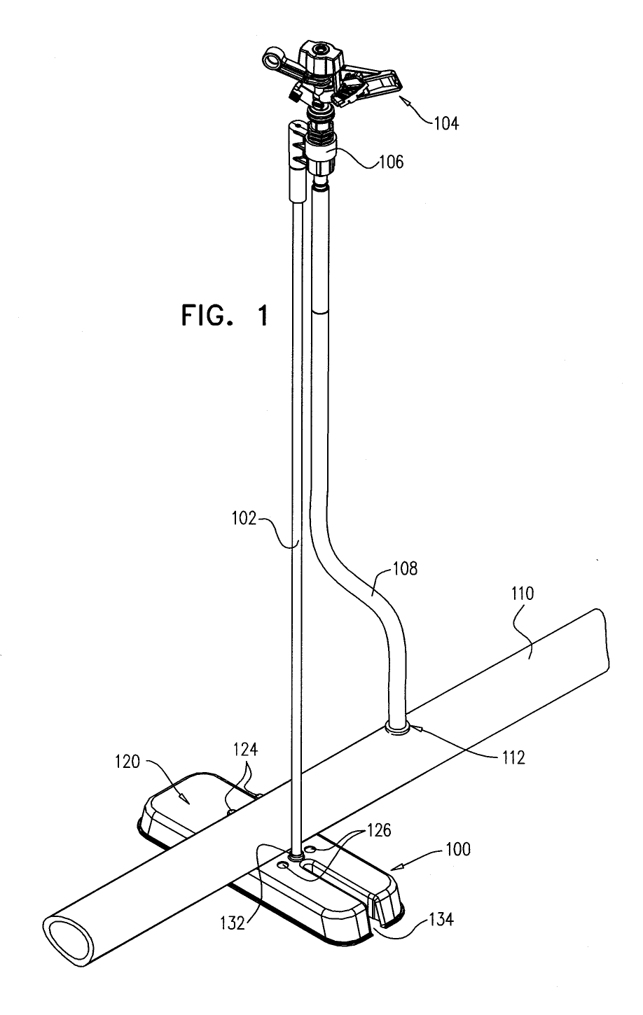

Reference is now made to FIG. 1, which is a simplified pictorial illustration of a sprinkler support constructed and operative in accordance with a preferred embodiment of the present invention. FIG. 1 shows the sprinkler support in use. As seen in FIG. 1, the sprinkler support includes a base member 100 and a sprinkler support rod 102.

As seen in FIG. 1, the base member 100 preferably lies horizontally on a support surface, such as the ground, and the sprinkler support rod 102 extends generally vertically upwardly from the base member 100 and is supported on the base member 100. A sprinkler 104 is preferably mounted on the top of sprinkler support rod 102, preferably via a mounting and water connecting element 106. A water supply tube 108 is connected between mounting and water connecting element 106 and a water supply conduit 110 preferably via a suitable coupler 112. Sprinklers 104 are commercially available, typically together with elements 106, 108 and 112, from NAANDANJAIN under various product designations such as Super 10 and 5022.

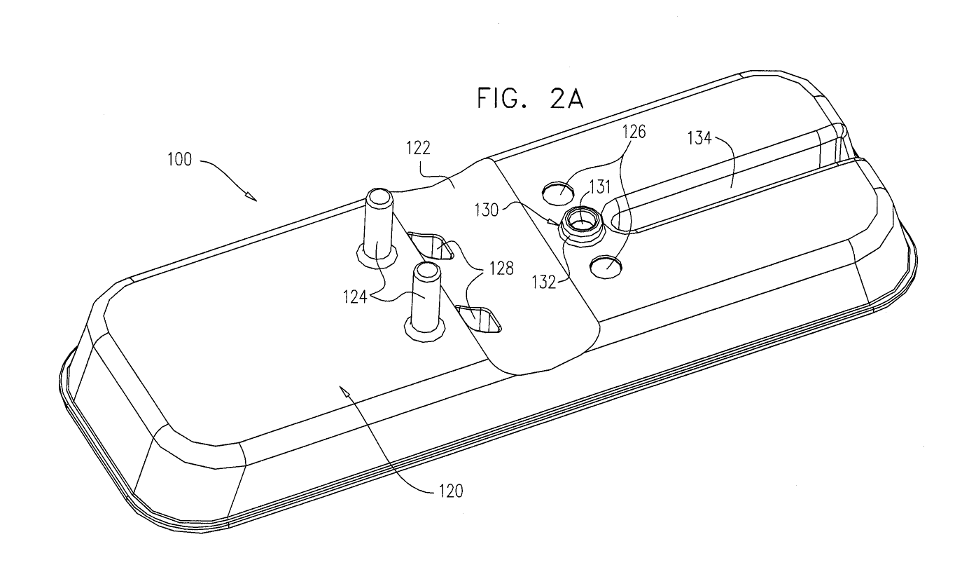

Turning now additionally to FIGS. 2A & 2B, it is seen that base member 100 is a generally rectangular element which is preferably configured to define an upward facing base surface 120 having a recess 122 extending transversely across base surface 120 for receiving water supply conduit 110 (FIG. 1). At least one, and preferably two, upstanding portions 124 are located alongside one side of recess 122 for limiting lateral movement of water supply conduit 110 with respect to base surface 120.

It is appreciated that in operation, as seen in FIG. 1, water supply conduit 110 lies in recess 122 and is retained in position in recess 122 by upstanding portions 124. The presence of water supply conduit 110 stabilizes base member 120.

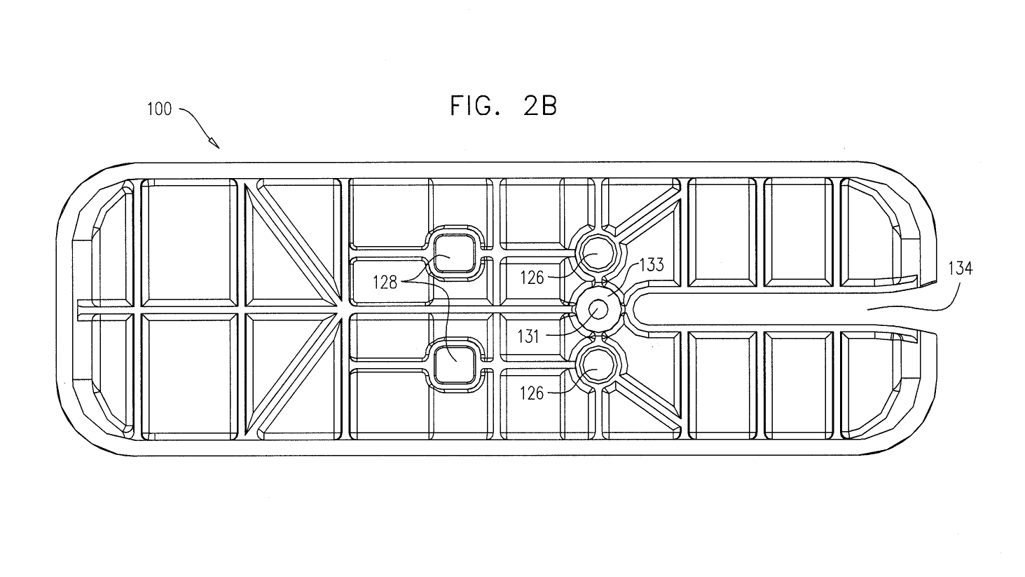

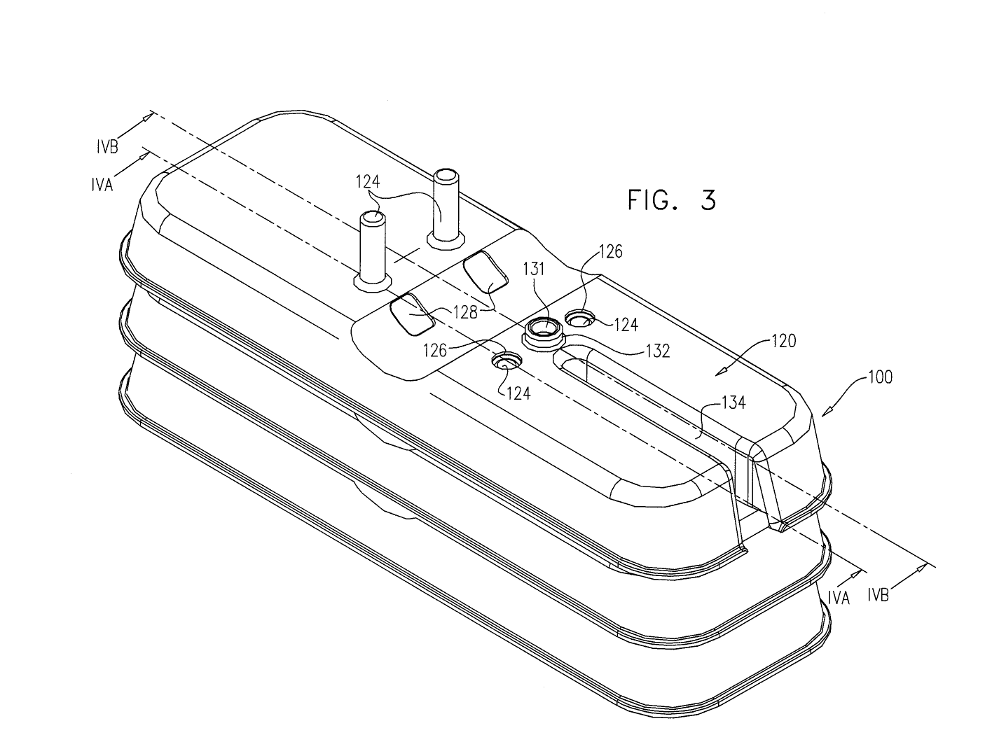

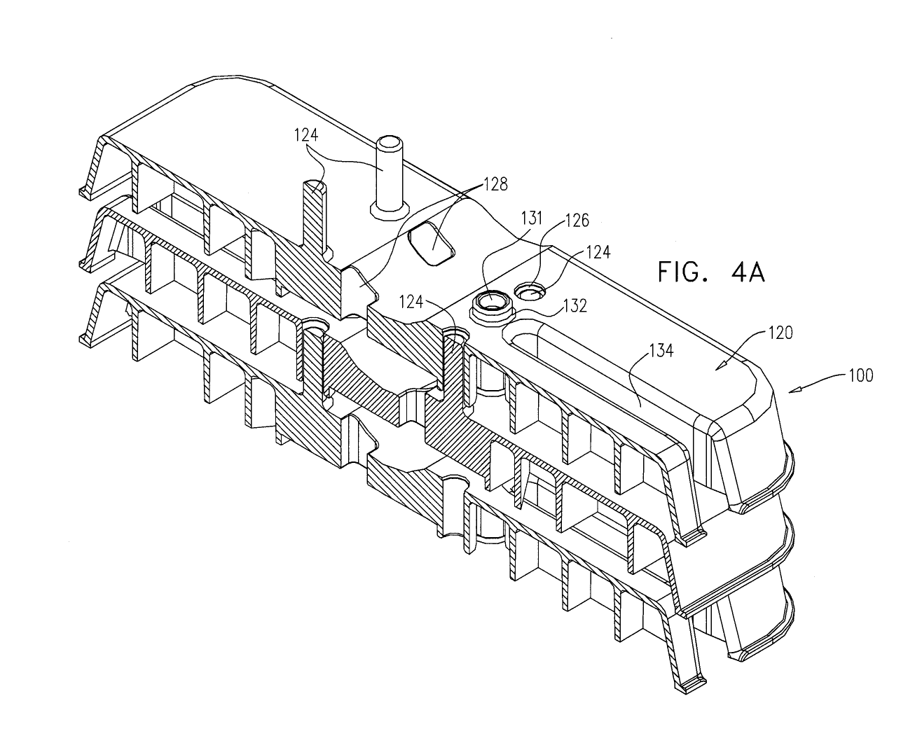

In accordance with a preferred embodiment of the present invention, at least one, and preferably two, first upstanding portion receiving apertures 126 are formed in base member 120 for receiving at least one, and preferably two, upstanding portions 124 of another base member 100 when stacked therewith in registration therewith, as shown in FIGS. 3-4B.

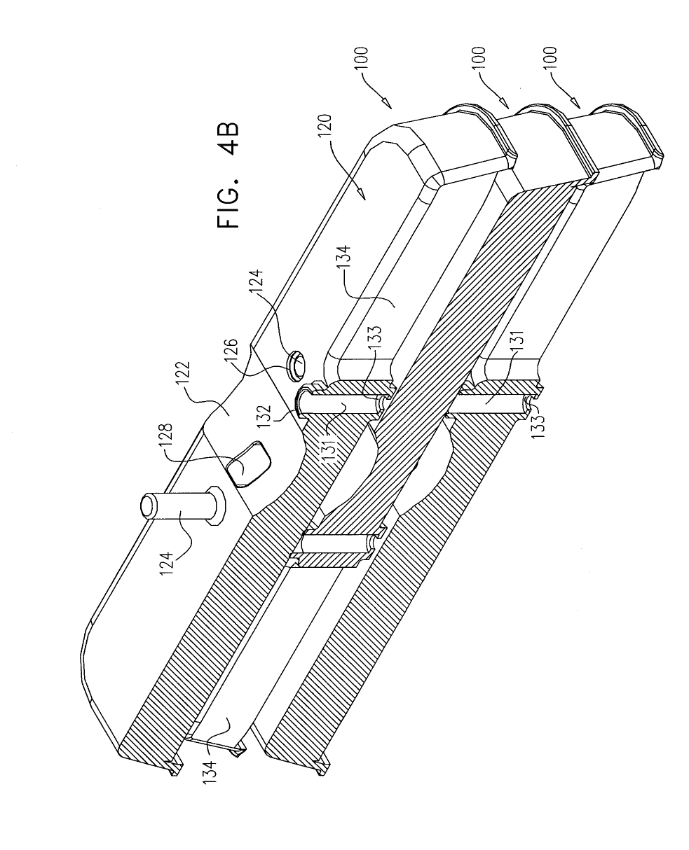

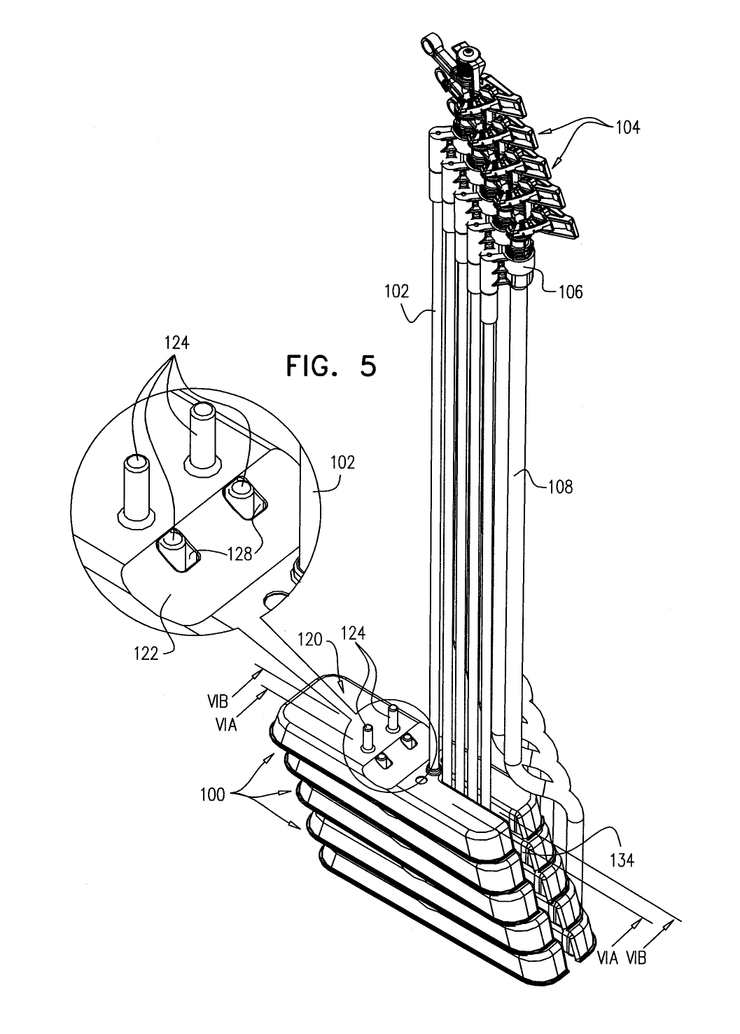

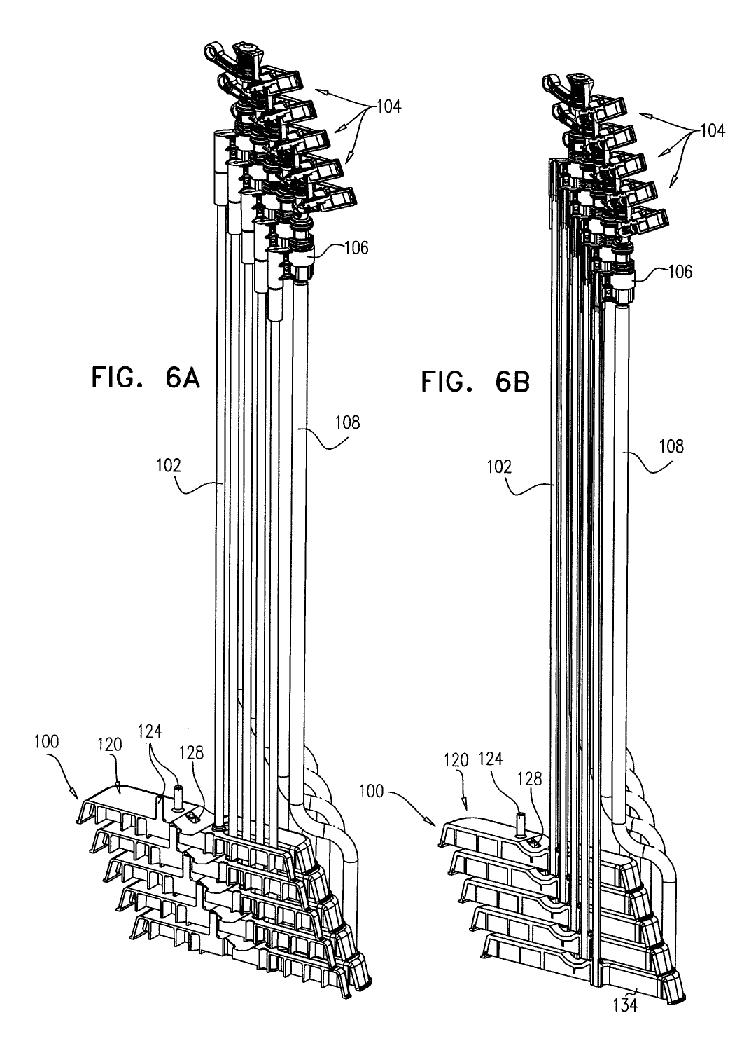

Further in accordance with a preferred embodiment of the present invention, at least one, and preferably two, second upstanding portion receiving apertures 128 are formed in base member 100 for receiving at least one, and preferably two, upstanding portions 124 of another base member 100 when stacked therewith in mutually offset relationship therewith, as shown in FIGS. 5-6B.

There is also provided on base surface 120 a sprinkler support rod support portion 130, configured to receive and support elongated sprinkler support rod 102 and typically including a stepped bore 131 bordered by an upstanding rim 132. Support portion 130 also includes a ring potion 133, near a lower end thereof, to receive elongated sprinkler support rod 102. It is appreciated that in operation ring portion 133 may be operative to limit downward movement of sprinkler support rod 102 in bore 131. Alternatively, ring portion 133 may be obviated and sprinkler support rod 102 may fit in bore 131.

Preferably a slot 134 is formed in base member 100 for accommodating at least one sprinkler support rod 102 mounted on at least one other base member 100, when at least one other base member is stacked therewith in mutually offset relationship therewith as seen in FIGS. 5-6B.

Reference is now made to FIG. 3, which is a simplified pictorial illustration of multiple base members 100 stacked, as for shipping and storage, in mutually 180 degree rotated, overall registration, to FIG. 4A, which is a sectional illustration, taken along lines IVA-IVA in FIG. 3 and to FIG. 4B, which is a sectional illustration, taken along lines IVB-IVB in FIG. 3. It is seen that adjacent stacked base members 100 are rotated with respect to each other by 180 degrees, such that upstanding portions 124 partially seat in upstanding portion receiving apertures 126, as seen particularly in FIG. 4A.

Reference is now made to FIG. 5, which is a simplified pictorial illustration of multiple sprinkler supports stacked for transport and storage between uses in mutually offset registration together with associated sprinklers 104 and elements 106, 108 and 112, to FIG. 6A, which is a sectional illustration, taken along lines VIA-VIA in FIG. 5 and to FIG. 6B, which is a sectional illustration, taken along lines VIB-VIB in FIG. 5.

It is seen that adjacent stacked base members 100 are not rotated with respect to each other but are axially offset with respect to each other, such that upstanding portions 124 partially seat in upstanding portion receiving apertures 128, as seen particularly in FIG. 6A. It is also seen that adjacent stacked sprinkler support rods 102 are axially offset with respect to each other and extend through slots 134 of adjacent base members 100, as seen particularly in FIG. 6B.

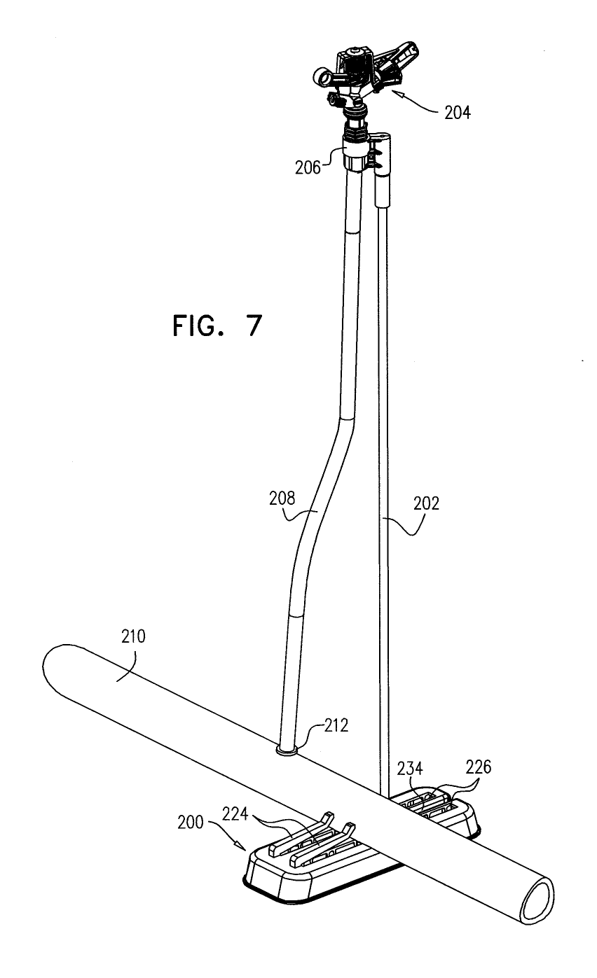

Reference is now made to FIG. 7, which is a simplified pictorial illustration of a sprinkler support constructed and operative in accordance with another preferred embodiment of the present invention. FIG. 7 shows the sprinkler support in use. As seen in FIG. 7, the sprinkler support includes a base member 200 and a sprinkler support rod 202.

As seen in FIG. 7, the base member 200 preferably lies horizontally on a support surface, such as the ground, and the sprinkler support rod 202 extends generally vertically upwardly from the base member 200 and is supported on the base member 200. A sprinkler 204 is preferably mounted on the top of sprinkler support rod 202, preferably via a mounting and water connecting element 206. A water supply tube 208 is connected between mounting and water connecting element 206 and a water supply conduit 210 preferably via a suitable coupler 212. Sprinklers 204 are commercially available, typically together with elements 206, 208 and 212, from NAANDANJAIN under various product designations such as Super 10 and 5022.

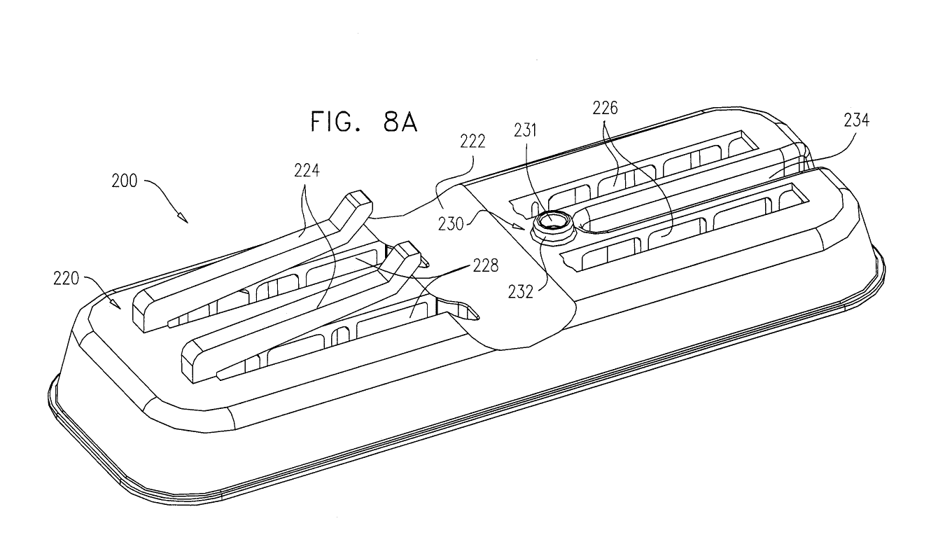

Turning now additionally to FIGS. 8A & 8B, it is seen that base member 200 is a generally rectangular element which is preferably configured to define an upward facing base surface 220 having a recess 222 extending transversely across base surface 220 for receiving water supply conduit 210 (FIG. 7). At least one, and preferably two, resilient water supply conduit engaging fingers 224 are located alongside one side of recess 222 for limiting lateral movement of water supply conduit 210 with respect to base surface 220 in cooperation with sprinkler support rod 202.

It is appreciated that in operation, as seen in FIG. 7, water supply conduit 210 lies in recess 222 and is retained in position in recess 222 by resilient water supply conduit engaging fingers 224. The presence of water supply conduit 210 stabilizes base member 220.

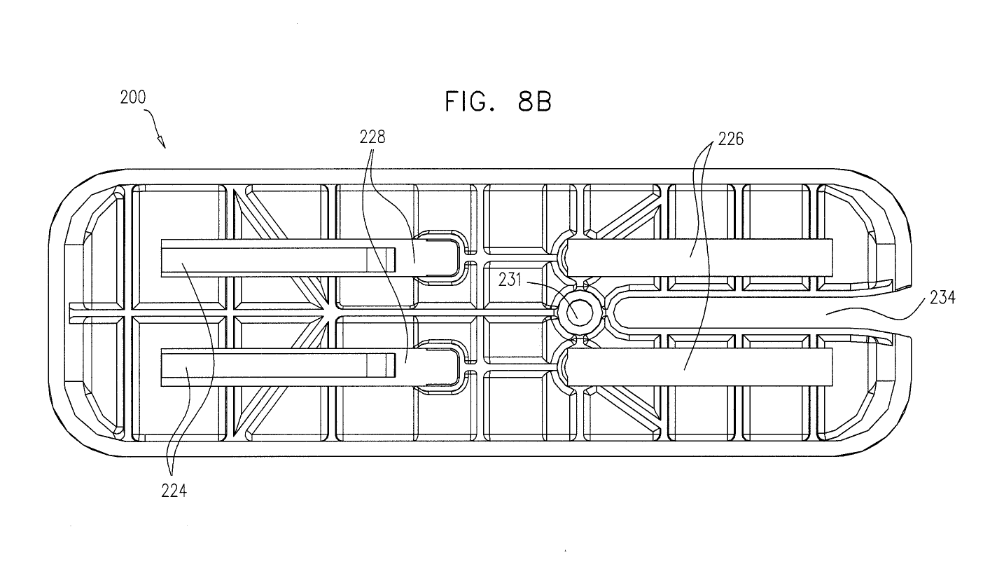

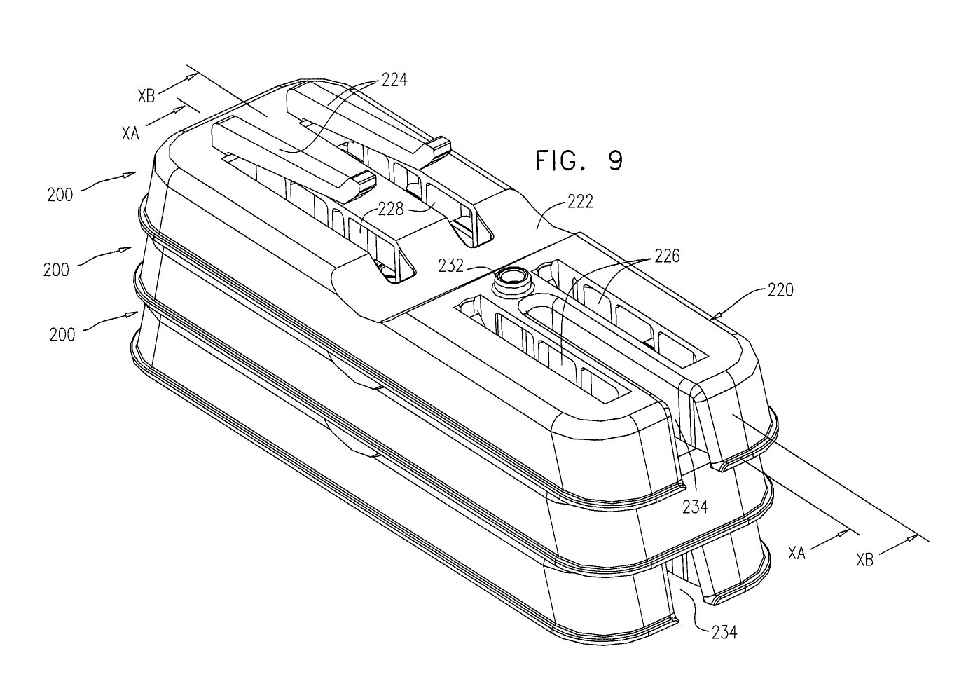

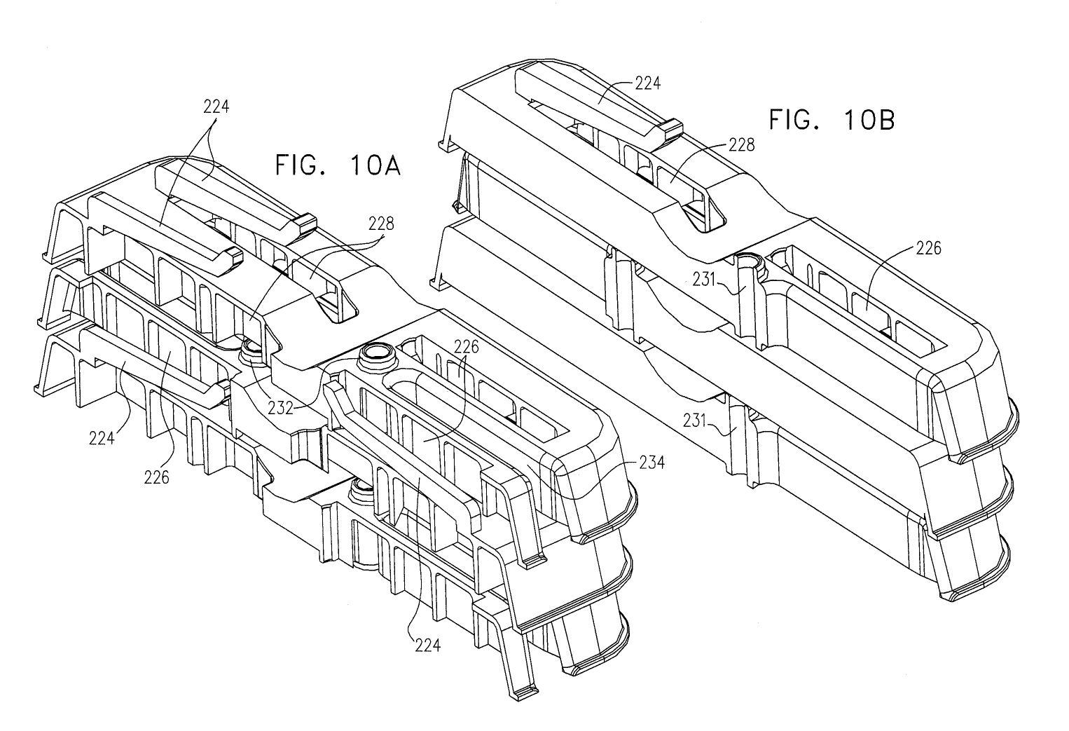

In accordance with a preferred embodiment of the present invention, at least one, and preferably two, first retaining finger receiving apertures 226 are formed in base member 220 for receiving at least one, and preferably two, resilient water supply conduit engaging fingers 224 of another base member 200 when stacked therewith in registration therewith, as shown in FIGS. 9-10B.

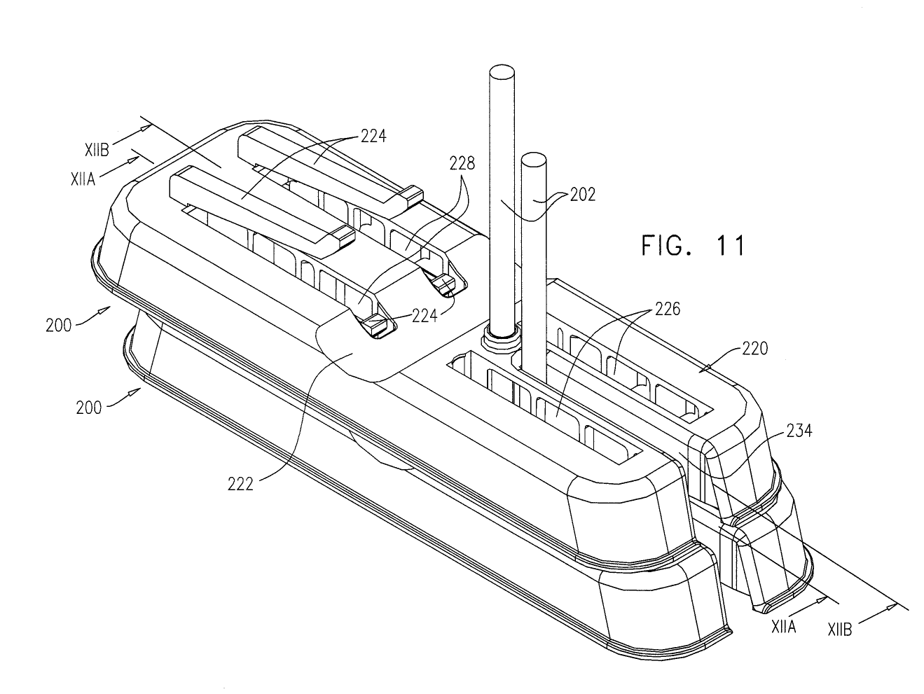

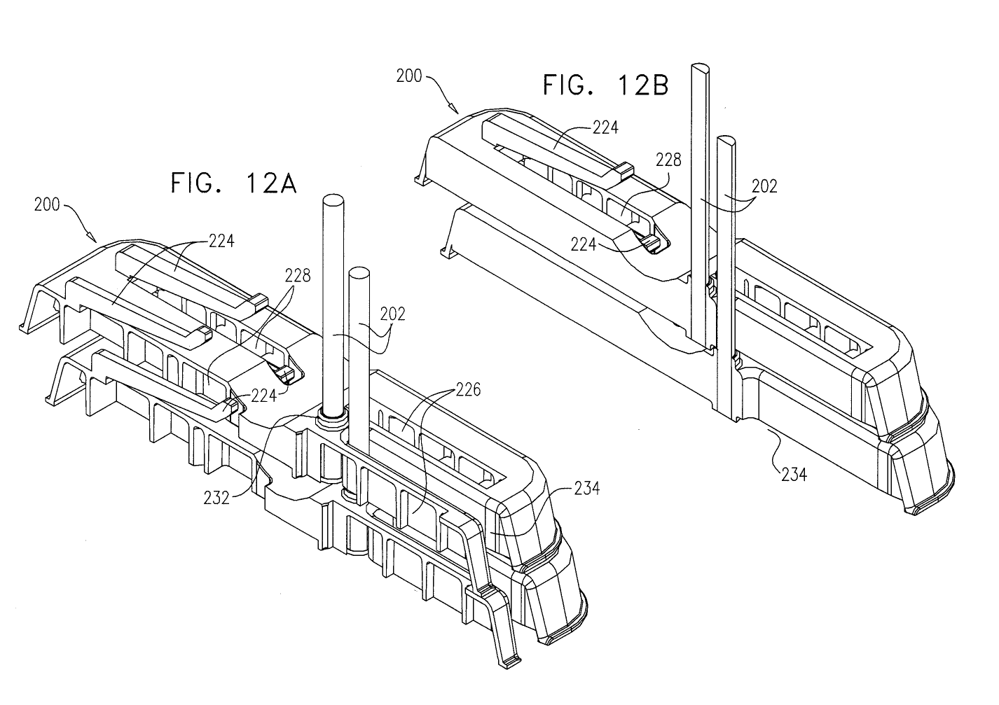

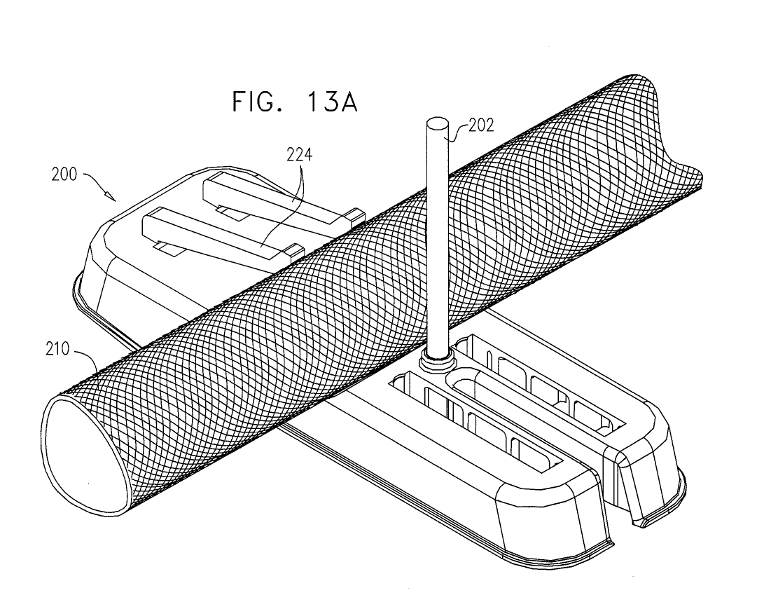

Further in accordance with a preferred embodiment of the present invention, at least one, and preferably two, second resilient water supply conduit retaining finger receiving apertures 228 are formed in base member 200 for receiving at least one, and preferably two resilient, water supply conduit engaging fingers 224 of another base member 200 when stacked therewith in mutually offset relationship therewith, as shown in FIGS. 11-12B.

There is also provided on base surface 220 a sprinkler support rod support portion 230, configured to receive and support elongated sprinkler support rod 202 and typically including a stepped bore 231 bordered by an upstanding rim 232.

Preferably a slot 234 is formed in base member 200 for accommodating at least one sprinkler support rod 202 mounted on at least one other base member 200, when at least one other base member is stacked therewith in mutually offset relationship therewith as seen in FIGS. 11-12B.

Reference is now made to FIG. 9, which is a simplified pictorial illustration of multiple base members 200 stacked, as for shipping and storage, in mutually 180 degree rotated, overall registration, to FIG. 10A, which is a sectional illustration, taken along lines XA-XA in FIG. 9 and to FIG. 10B, which is a sectional illustration, taken along lines XB-XB in FIG. 9. It is seen that adjacent stacked base members 200 are rotated with respect to each other by 180 degrees, such that resilient water supply conduit engaging fingers 224 at least partially seat in resilient water supply conduit retaining finger receiving apertures 226, as seen particularly in FIG. 10A.

Reference is now made to FIG. 11, which is a simplified pictorial illustration of multiple sprinkler supports stacked for transport and storage between uses in mutually offset registration together with associated sprinklers 204 and elements 206, 208 and 212, to FIG. 12A, which is a sectional illustration, taken along lines XIIA-XIIA in FIG. 11 and to FIG. 12B, which is a sectional illustration, taken along lines XIIB-XIIB in FIG. 11.

It is seen that adjacent stacked base members 200 are not rotated with respect to each other but are axially offset with respect to each other, such that resilient water supply conduit engaging fingers 224 at least partially seat in resilient water supply conduit retaining finger receiving apertures 228, as seen particularly in FIG. 12A. It is also seen that adjacent stacked sprinkler support rods 202 are axially offset with respect to each other and extend through slots 234 of adjacent base members 200, as seen particularly in FIG. 12B.

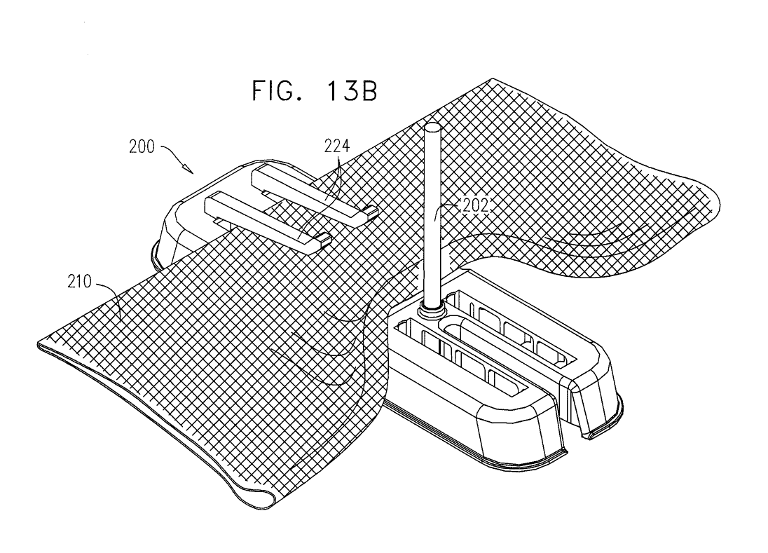

Reference is now made to FIGS. 13A and 13B, which are respective simplified illustrations illustrating engagement of the sprinkler support of FIGS. 1-12B with a thin walled water supply conduit in respective pressurized and non-pressurized operative orientations. It is seen that resilient water supply conduit retaining fingers 224 are flexed upwardly to accommodate the resilient water supply conduit 210 when it is pressurized, as shown in FIG. 13A. FIG. 13B shows that when the resilient water supply conduit 210 is unpressurized, it is clamped by resilient retaining fingers 224 to the base member 200.

It will be appreciated by persons skilled in the art that the present invention is not limited by what has been particularly shown and described hereinabove. Rather the scope of the present invention includes combinations and subcombinations of the features described hereinabove as well as modifications thereto which would occur to persons skilled in the art and are not in the prior art.

1. A sprinkler support comprising a base member configured to define:
an upward facing base surface;
a recess extending across said base surface for receiving a water supply conduit;
at least one resilient water supply conduit retaining finger located alongside one side of said recess for retaining said water supply conduit with respect to said base surface;
at least one first resilient water supply conduit retaining finger receiving aperture formed in said base member for receiving said at least one resilient water supply conduit retaining finger of another base member when stacked therewith in mutually 180 degree rotated, overall registration therewith;
at least one second resilient water supply conduit retaining finger receiving aperture formed in said base member for receiving said at least one resilient water supply conduit retaining finger of another base member when stacked therewith in mutually offset relationship therewith; and
a sprinkler support rod support portion, configured to receive and support an elongated sprinkler support rod.

2. A sprinkler support according to claim 1 and wherein a slot is formed in said base member for accommodating at least one sprinkler support rod mounted on at least one other base member, when said at least one other base member is stacked therewith in mutually offset relationship therewith.

3. A sprinkler support according to claim 1 and also comprising a sprinkler support rod mounted on said sprinkler support rod support portion.

4. A sprinkler support according to claim 3 and also comprising a sprinkler mounted on said sprinkler support rod.

5. A sprinkler support according to claim 4 and wherein said sprinkler is mounted on said sprinkler support rod via a mounting and water connecting element and wherein a water supply tube is connected to said mounting and water connecting element and is adapted for connection to a water supply conduit via a coupler.

6. A sprinkler support according to claim 1 and wherein said water supply conduit lies in said recess and is retained therein by said at least one resilient water supply conduit retaining finger.

7. A sprinkler support according to claim 1 and wherein said at least one resilient water supply conduit retaining finger clamps said water supply conduit to said base member when said water supply conduit is unpressurized.

8. A sprinkler support comprising a base member configured to define:
an upward facing base surface;
a recess extending across said base surface for receiving a water supply conduit;
a sprinkler support rod support portion, configured to receive and support an elongated sprinkler support rod; and
a slot formed in said base member for accommodating at least one sprinkler support rod mounted on at least one other base member, when said at least one other base member is stacked therewith in mutually offset relationship therewith.

9. A sprinkler support according to claim 8 and also comprising at least one resilient water supply conduit retaining finger located alongside one side of said recess for limiting lateral movement of said water supply conduit with respect to said base surface.

10. A sprinkler support according to claim 9 and also comprising at least one upstanding portion located alongside one side of said recess for limiting lateral movement of said water supply conduit with respect to said base surface.

11. A sprinkler support according to claim 8 and also comprising a sprinkler support rod mounted on said sprinkler support rod support portion.

12. A sprinkler support according to claim 11 and also comprising a sprinkler mounted on said sprinkler support rod.

13. A sprinkler support according to claim 12 and wherein said sprinkler is mounted on said sprinkler support rod via a mounting and water connecting element and wherein a water supply tube is connected to said mounting and water connecting element and is adapted for connection to a water supply conduit via a coupler.

14. A sprinkler support according to claim 9 and wherein said water supply conduit lies in said recess and is retained therein by at least one resilient water supply conduit retaining finger.

15. A sprinkler support comprising a base member configured to define:
an upward facing base surface;
a recess extending across said base surface for receiving a water supply conduit;
at least one upstanding portion located alongside one side of said recess for retaining said water supply conduit with respect to said base surface;
at least one first upstanding portion receiving aperture formed in said base member for receiving said at least one upstanding portion of another base member when stacked therewith in mutually 180 degree rotated, overall registration therewith;
at least one second upstanding portion receiving aperture formed in said base member for receiving said at least one upstanding portion of another base member when stacked therewith in mutually offset relationship therewith; and
a sprinkler support rod support portion, configured to receive and support an elongated sprinkler support rod.

16. A sprinkler support according to claim 15 and wherein a slot is formed in said base member for accommodating at least one sprinkler support rod mounted on at least one other base member, when said at least one other base member is stacked therewith in mutually offset relationship therewith.

17. A sprinkler support according to claim 15 and also comprising a sprinkler support rod mounted on said sprinkler support rod support portion.

18. A sprinkler support according to claim 17 and also comprising a sprinkler mounted on said sprinkler support rod.

19. A sprinkler support according to claim 18 and wherein said sprinkler is mounted on said sprinkler support rod via a mounting and water connecting element and wherein a water supply tube is connected to said mounting and water connecting element and is adapted for connection to a water supply conduit via a coupler.

20. A sprinkler support according to claim 15 and wherein said water supply conduit lies in said recess and is retained therein by said at least one upstanding portion.
